(19) United States
(12) Patent Application Publication
(10) Pub. No.: US 2026/0148952 A1
(43) Pub. Date: May 28, 2026

(54) VUV LASER-SUSTAINED PLASMA LIGHT SOURCE WITH DIRECT GAS FLOW

(71) Applicant: KLA Corporation, Milpitas, CA (US)

(72) Inventor: Ilya Bezel, Mountain View, CA (US)

(21) Appl. No.: 19/393,256

(22) Filed: Nov. 18, 2025

Related U.S. Application Data
(60) Provisional application No. 63/723,584, filed on Nov. 21, 2024.

(51) Int. Cl. H01J 61/28; H01J 61/02; H01J 61/16; H01J 65/04

(52) U.S. Cl. CPC H01J 61/28; H01J 61/025; H01J 61/16; H01J 65/042

(57) ABSTRACT

A high-power vacuum ultraviolet laser-sustained broadband plasma light source is disclosed. The light source includes a laser pump source to sustain a plasma within a gas chamber assembly. The gas chamber assembly includes a gas chamber and a laser input for directing a laser pump beam into a plasma region and a laser output for transmitting unabsorbed laser pump light outside the chamber. The gas chamber assembly includes one or more broadband output windows. The gas chamber assembly includes one or more transparent nozzles configured to direct gas flow into the plasma region and transmit the one or more laser pump beams to the plasma region. The gas chamber assembly includes one or more transparent cones configured to shield one or more optical collection paths from gas flow. The gas chamber assembly includes gas inlets and outlets for maintaining gas flow through the plasma region.

### CROSS-REFERENCE TO RELATED APPLICATION

The present application claims priority to U.S. Provisional Application Ser. No. 63/723,584, filed Nov. 21, 2024, which is incorporated herein by reference in their entirety.

### TECHNICAL FIELD

The present disclosure generally relates to broadband light generation for semiconductor device inspection, and, more particularly, to a compact high-power laser-sustained plasma light source for inspection within the vacuum ultraviolet (VUV) spectral region.

### BACKGROUND

Laser-sustained plasma (LSP) light sources are widely used in broadband inspection tools for use in semiconductor inspection and imaging. Generally, a continuous-wave laser is focused into a gas-containing vessel, where the laser radiation initiates and sustains a plasma. This vessel may be a lamp (e.g., a glass bulb with or without electrodes for plasma initiation), a cell (e.g., an optomechanical assembly with transparent walls to permit laser and plasma radiation exchange), or a chamber (e.g., a metal enclosure with transparent windows for both input laser light and output plasma light), or a similar configuration. The vessel is typically designed to contain high-pressure gas, often reaching tens to over a hundred atmospheres, a condition that is necessary for ensuring proper plasma formation and stability. The plasma emits broadband radiation that is collected through the transparent windows or walls, which is then utilized for various diagnostic and illumination tasks.

There have been various adaptations of these plasma-based light sources to extend their utility into the vacuum ultraviolet (VUV) spectral region. Achieving VUV operation requires materials that offer high optical transmission and robust mechanical integrity under elevated thermal loads. Commonly used materials for VUV applications, such as magnesium fluoride (MgF₂), have a transmission cut-off wavelength of approximately 115 nm. However, MgF₂ windows are susceptible to optical damage, particularly from short-wavelength radiation below 125 nm emitted by the plasma. This damage can degrade the windows rapidly, compromising their structural integrity and optical performance.

Moreover, the high-pressure environment within the plasma chamber imposes practical limits on the size and thickness of the windows. If the windows are positioned close to the plasma, they are exposed to intense radiation, leading to rapid degradation. Conversely, if the windows are positioned further away, they must be larger to maintain the same collection numerical aperture (NA), which requires them to be thicker and bulkier.

Thermal management of windows, mirrors, and chamber walls is another critical issue. The absorption of broadband radiation by these components can lead to significant heat accumulation, jeopardizing their structural strength. For instance, cooling an MgF₂ window requires substantial heat removal, which is difficult due to the material's poor thermal conductivity. This problem is exacerbated for mirrors, which absorb a fraction of the plasma's full broadband radiation, resulting in even higher thermal loads.

Additionally, controlling convection within the chamber is complex. Structural components are heated by plasma radiation and the hot gas plume, creating thermal gradients that cause refractive deflection of the pump laser rays. Erratic gas flow can introduce noise into the plasma, affecting its stability and brightness.

Given these challenges, there is a need for a VUV light source that can overcome the limitations of existing designs, particularly in terms of optical damage, thermal management, and gas flow control, while supporting enhanced performance in demanding applications.

### SUMMARY

The present disclosure relates to a high-power VUV laser-sustained plasma broadband light source. In some aspects, the light source includes a laser pump source configured to generate one or more laser pump beams for sustaining a plasma. In some aspects, the light source includes a gas chamber assembly comprising a chamber configured to contain a gas, a laser input configured to couple the one or more laser pump beams from the laser pump source into a plasma region within the chamber to sustain the plasma, and a laser output configured to transmit unabsorbed laser pump light outside of the chamber. In some aspects, the gas chamber assembly includes one or more broadband output windows configured to transmit broadband light from the plasma outside of the chamber. In some aspects, the gas chamber assembly includes one or more transparent nozzles positioned within the chamber and configured to direct gas flow into the plasma region and transmit the one or more laser pump beams to the plasma region. In some aspects, the gas chamber assembly includes one or more transparent cones positioned within the chamber and configured to shield one or more optical collection paths from gas flow. In some aspects, the gas chamber assembly includes one or more gas inlets, and one or more gas outlets configured to provide a flow of the gas through the plasma region. In some aspects, the light source includes a light collector element configured to collect broadband light emitted from the plasma and transmitted through the one or more broadband output windows. The laser input may include at least one of a lens, window, or filter, including sapphire lenses or windows, and the chamber may be a metal chamber. The transparent nozzles and cones may be formed from sapphire.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures.

FIG. 1 illustrates a schematic cross-sectional view of a broadband light source including a gas chamber assembly for generating high-power VUV broadband light, in accordance with one or more embodiments of the present disclosure.

FIG. 2 illustrates a cross-sectional schematic of the broadband light source highlighting the gas chamber assembly, plasma region, and associated optical and thermal management components, in accordance with one or more embodiments of the present disclosure.

FIG. 3 illustrates a schematic diagram of a broadband light source including a retroreflector for enhancing light collection from the plasma, in accordance with one or more embodiments of the present disclosure.

FIG. 4 illustrates a schematic diagram of a broadband light source including a multi-pass optical configuration for enhancing light collection efficiency, in accordance with one or more embodiments of the present disclosure.

FIG. 5 illustrates a schematic diagram of an optical characterization system incorporating the broadband light source for sample inspection, in accordance with one or more embodiments of the present disclosure

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to a compact high-power flow-through VUV laser-sustained plasma light source including transparent structures for reducing optical damage and assisting with thermal management and gas flow. A gas flow arrangement may be implemented, featuring a flow-through design with a sub-sonic transparent nozzle (e.g., sapphire nozzle) to direct high-pressure gas into the plasma, thereby improving plasma stability and brightness. Additional transparent structures, such as a transparent cone (e.g., sapphire cone), may ensure that plasma light first encounters transparent, low-absorptive materials before reaching chamber walls, reducing radiative thermal load and extending the operational lifespan of the light source.

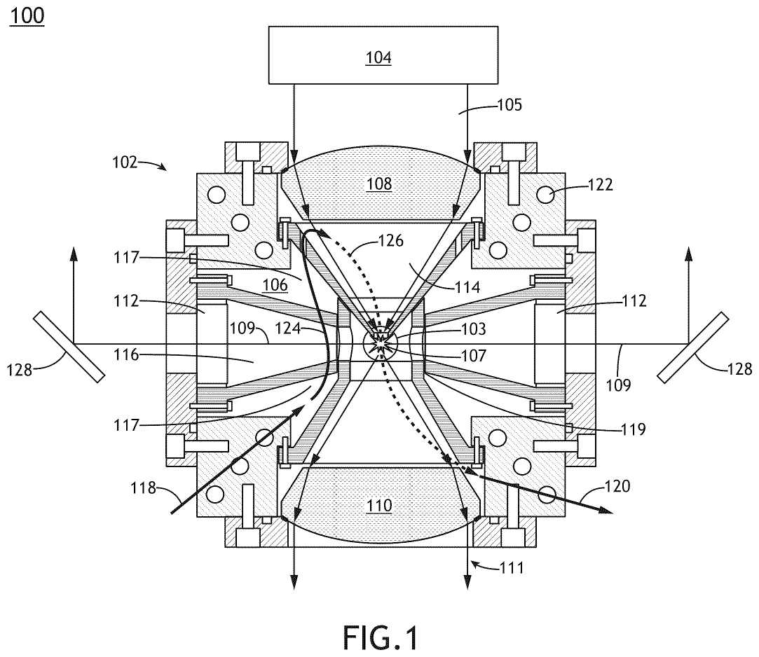

FIG. 1 illustrates a cross-section view of a LSP broadband light source 100 for generating high-power VUV broadband light, in accordance with one or more embodiments of the present disclosure. In embodiments, the broadband light source 100 includes a gas chamber assembly 102, a laser pump source 104 for generating one or more laser pump beams 105 for sustaining a plasma 107 within a plasma region 103, and one or more light collector elements 128 for collecting broadband light 109 emitted from the plasma 107 and transmitted through the one or more broadband output windows 112.

In embodiments, the gas chamber assembly 102 includes a chamber 106 configured to contain a gas for generating plasma 107. For example, the chamber 106 may include a metal chamber suitable for containing high-pressure gas (e.g., approximately 100 bar) for plasma generation.

In embodiments, the gas chamber assembly 102 includes a laser input 108 configured to couple the one or more laser pump beams 105 from the laser pump source 104 into a plasma region 103 within the chamber 106 to sustain the plasma 107. In this regard, the laser pump source 104 may direct the laser pump beam 105 through the laser input 108 to sustain the plasma 107 within the chamber 106 to generate broadband light 109. In embodiments, the gas chamber assembly 102 includes a laser output 110 configured to transmit unabsorbed laser pump light outside of the chamber 106. For example, the laser output 110 may transmit unabsorbed laser light 111 to a beam dump located outside of the chamber 106. The laser input 108 and the laser output 110 may include any optical element formed from a material transparent to all or a portion of the spectral components of the laser pump beam 105. For example, the laser input 108 and/or the laser output 110 may include, but are not limited to, a window, a lens, or a filter. For instance, the laser input 108 and/or the laser output 110 may include, but are not limited to, a sapphire lens or window. In embodiments, as shown in FIG. 1, the laser input 108 and/or the laser output 110 may be mechanically secured to the chamber 106. For instance, the laser input 108 and/or the laser output 110 may be secured to the chamber wall via a bracket.

The laser pump source 104 may include any laser known in the art of plasma-based broadband light generation. In embodiments, the laser pump source 104 may include one or more continuous wave (CW) pump lasers and/or one or more pulsed lasers. For example, the laser pump source 104 may include, but is not limited to, a fiber laser, a thin-disk laser, a frequency-doubled laser, or a diode laser. The laser pump source 104 may be configured to emit light in the visible, IR (e.g., NIR), or ultraviolet regions. The laser pump beam may be focused and formed into a desired shape. For example, the laser pump beam 105 may be focused into a line extending the plasma 107 in the direction of the light collection. The laser pupil distribution may be bell-shaped, flat, inverted doughnut-like bell-shape, or the like.

In embodiments, the gas chamber assembly 102 includes one or more broadband output windows 112 configured to transmit broadband light 109 from the plasma 107 outside of the chamber 106. The one or more broadband output windows 112 are positioned to allow efficient extraction of the plasma's emission while maintaining the integrity of the high-pressure environment inside the chamber 106. To ensure high transmission in the VUV spectral region and withstand the intense thermal and optical loads produced during operation, the broadband output windows may be formed from materials such as, but not limited to, MgF₂, LiF, CaF₂, sapphire, or the like. These materials are selected for their transparency to VUV light and their mechanical robustness under elevated pressures and temperatures. By utilizing such materials, the broadband output windows enable reliable and efficient delivery of high-power VUV light for inspection, metrology, and imaging applications, while minimizing optical damage and maintaining long-term operational performance.

In embodiments, one or more collection or focusing optics may be placed within the chamber 106. For example, one or more collection lenses may be placed inside the pressurized volume of the chamber 106 to (partially) collimate the broadband light 109. Further, one or more lenses may be used to focus the broadband light 109 from the plasma 107 through a smaller size high-pressure output window 112.

In embodiments, one or more filters may be placed within the chamber 106. For example, a CaF₂ or MgF₂ filter may be placed within the chamber 106 so as to filter the broadband light 109 prior to it exiting the one or more broadband light windows 112.

In embodiments, the gas chamber assembly 102 includes one or more gas inlets 118 and one or more gas outlets 120. The one or more gas inlets 118 and the one or more gas outlets 120 are configured to provide a flow of gas 126 through the plasma region 103. The one or more gas inlets 118 and one or more gas outlets 120 may be high-pressure (e.g., approximately 100 bar).

In embodiments, the gas chamber assembly 102 includes one or more transparent nozzles 114 positioned within the chamber 106 and configured to direct gas flow 126 into the plasma region 103. In this regard, gas from the gas inlet 118 may be passed through the wall of nozzle 114 and directed toward the plasma 107. In addition, the one or more transparent nozzles 114 are transparent to light from the laser pump source 104 and transmit the one or more laser pump beams 105 to the plasma region 103 for pumping the plasma 107. The one or more transparent nozzles 114 may be formed from a variety of materials. For example, the one or more transparent nozzles 114 may be formed from transparent, low-absorptive material. For instance, the one or more transparent nozzles 114 may be formed from, but is not limited to, sapphire.

In embodiments, the gas chamber assembly 102 includes one or more transparent structures positioned within the chamber 106 and configured to shield one or more optical collection paths from gas flow 124. For example, the one or more transparent structures may include one or more transparent cones 116. The one or more transparent cones 116 may be positioned within the chamber 106 to shield the optical path(s) (e.g., optical collection path(s)) from disturbances caused by the gas flow 124 within the chamber 106. For example, gas enters the gas chamber 106 through the one or more gas inlets 118. In turn, the one or more transparent cones 116 divert the intermediate gas flow 124 such that the gas flow 124 flows through a volume 117 of the chamber 106 that is outside of the internal volume of the one or more transparent cones 116. Then, the intermediate gas flow 124 may enter the one or more transparent nozzles 114 which then directs the gas flow 126 toward the plasma region 103. The one or more transparent cones 116 help mitigate the effects of “air wiggle,” or uncontrolled convection, which can introduce noise and aberrations into the collected light. The one or more transparent cones 116 may be constructed from a material having high optical transparency and high thermal conductivity. For example, the one or more transparent cones 116 may be formed from sapphire. The one or more transparent cones 116 ensure that the optical path(s) remains clear and free from refractive distortions caused by thermal gradients. It is noted that the gas flow path indicated by the lines 124, 126 are provided for illustrative purposes and should not be interpreted as a limitation on the scope of the present disclosure. It is recognized herein that the internal transparent structures 114, 116 may be utilized to form a variety of gas flow arrangements which mitigate the effects of uncontrolled convection within the gas chamber 106. These structures are not limited to conical features, and a variety of shapes may be implemented within the scope of the present disclosure. For example, the transparent structure 116 and/or transparent nozzle 114 may have a conical, cylindrical, composite, or irregular shape.

In embodiments, the gas chamber assembly 102 includes a gas junction 119 configured to couple the one or more transparent structures and the one or more transparent nozzles. In this regard, the gas junction 119 may mechanically connect the one or more transparent structures and the one or more transparent nozzles.

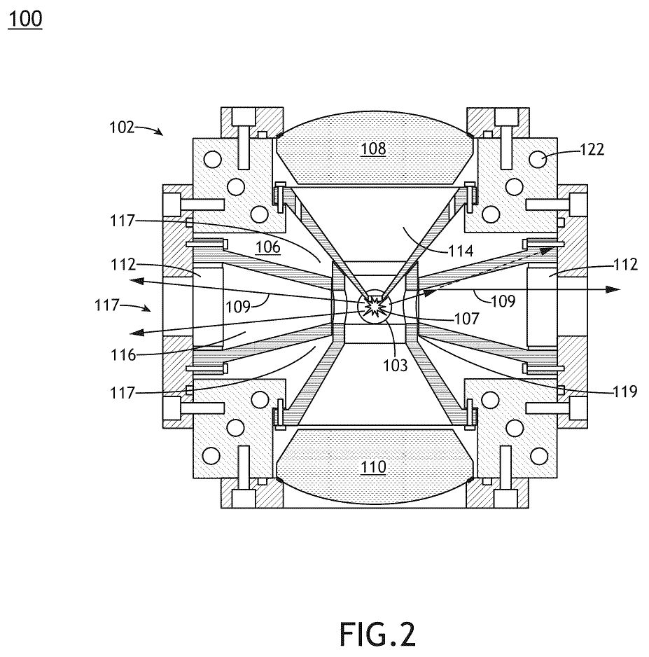

In embodiments, as shown in FIG. 2, in addition to enhancing the efficiency of light collection, the configuration also protects the structural components of the chamber 106 from direct exposure to intense plasma radiation. In this regard, the one or more transparent cones 116 may reduce the thermal load on the structural components. In embodiments, the one or more transparent cones 116 may reflect broadband light 109 in a way that the broadband light 109 deviates from its normal path 202 and does not impinge on one or more of the structural components.

The configuration of the gas chamber assembly 102 allows for the removal of metal parts as far as possible from the plasma region 103 which reduces radiative thermal load on these parts. Plasma light 109 first encounters transparent components constructed from low-absorptive materials (e.g., MgF₂ windows, sapphire lenses, sapphire cones, etc.). These components are used to direct the plasma light outside of the chamber 106, or scatter or refract the plasma light in such a way that it is not directly irradiating the metal parts of the chamber, thereby reducing the radiative thermal load on chamber walls. Since the transparent components have low absorption, they do not undergo significant heating by the broadband light 109 from the plasma 107. Cooling of the transparent elements may occur conductively through the contact with water-cooled parts or convectively by flowing high-pressure gas in the chamber around them. In addition, structural components of the chamber 102 may be placed at relatively large distances from the plasma 107 to reduce the radiative heat load on the structural components and making their cooling easier and their operating temperature lower.

The gas contained within and flowed through the chamber 106 may include any gas known in the art of plasma generation. For example, the gas may include, but is not limited to, Ar, Kr, or Xe, and the like. The gas may include, but is not limited to, a mixture of two or more gases. For example, the gas may include, but is not limited to, a mixture of two or more of Ar, Kr, and Xe. It is noted that the addition of Xe to the gas mixture may block emission below about 132-136 nm and in the 144 nm to approximately 150-160 nm band depending on Xe partial pressure. For example, an Ar/Kr/Xe gas mixture (with a few percent of Kr and Xe) may be used in combination with optical components formed from crystal quartz, fused silica, sapphire, CaF₂, etc.

In embodiments, the chamber 106 includes one or more water cooling channels 122. The water cooling channels 122 are configured to circulate water or another cooling liquid through the chamber 106 to remove heat from the main construction elements of the chamber 106 exposed to laser and plasma light.

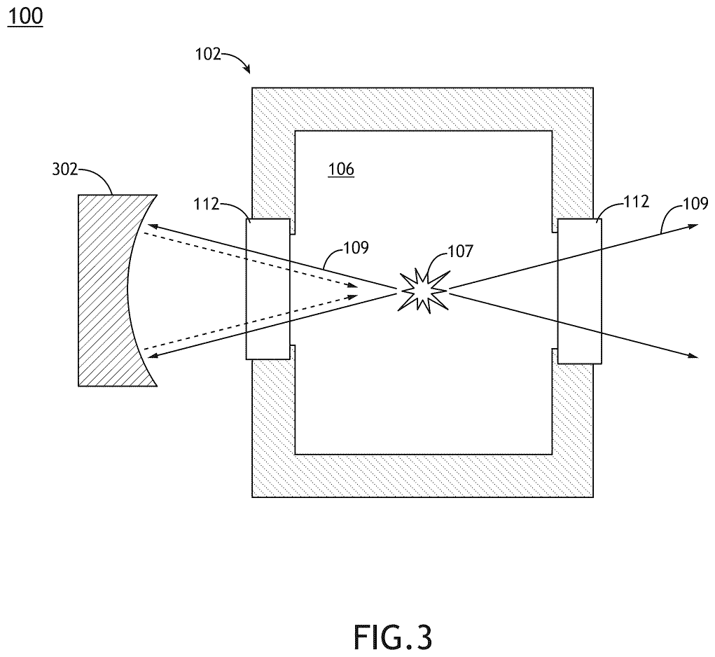

FIG. 3 illustrates a simplified schematic view of the broadband LSP light source 100 in a retroreflector configuration, in accordance with one or more embodiments of the present disclosure. It is noted that the various implementations and components of FIGS. 1-2 should be interpreted to apply to FIG. 3 unless otherwise noted. In this embodiment, a retroreflecting mirror 302 is positioned to reflect broadband light 109 back through the volume of the chamber 106 and the plasma region 103. This configuration allows for increased collected radiance by the light collector element 128 (not shown in FIG. 3). It is noted that the retroreflecting mirror 302 may be placed on the outside of the chamber 106, as shown in FIG. 3, or on the inside of the chamber 106.

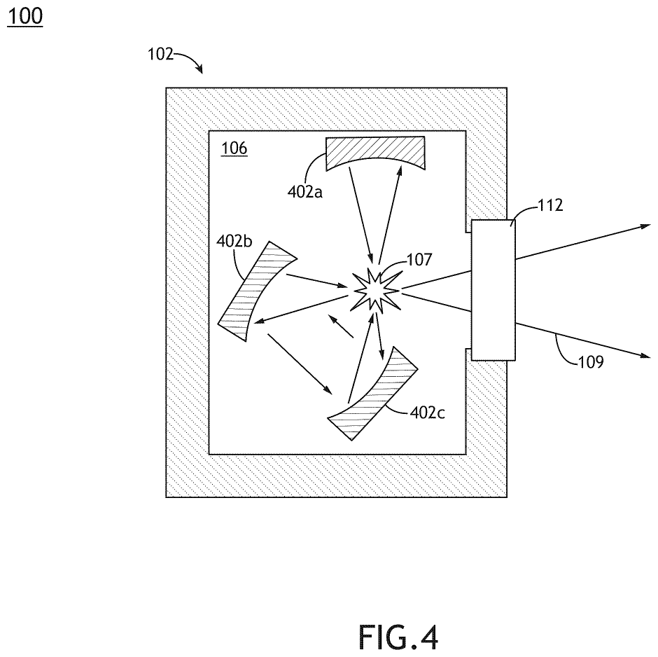

FIG. 4 illustrates a simplified schematic axial view of the broadband light source 100 with a multi-pass configuration, in accordance with one or more alternative and/or additional embodiments. It is noted that the various implementations and components of FIGS. 1-3 should be interpreted to apply to FIG. 4 unless otherwise noted. In this embodiment, a multi-pass collection arrangement may be implemented with the optics 402a, 402b, 402c needed for collection placed inside the chamber 106 or outside of the chamber 106. Multi-pass collection increases collected radiance. An example of four-pass collection is presented in FIG. 4. Large solid angle available for plasma light collection allows for various mirror arrangements, and lower damage to optical components allows placing the mirrors relatively close to the plasma 107 reducing the overall size of the broadband light source 100.

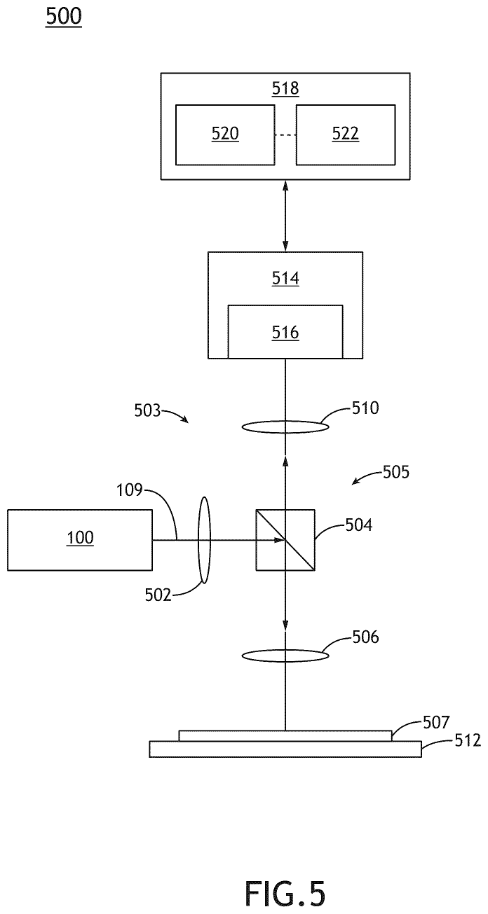

FIG. 5 illustrates a simplified schematic view of an optical characterization system 500 incorporating the compact LSP broadband light source, in accordance with one or more alternative and/or additional embodiments. In embodiments, system 500 includes the broadband LSP light source 100, an illumination arm 503, a collection arm 505, a detector assembly 514, and a controller 518 including one or more processors 520 and memory 522.

It is noted herein that system 500 may comprise any imaging, inspection, metrology, lithography, or other characterization system known in the art. In this regard, system 500 may be configured to perform inspection, optical metrology, lithography, and/or any form of imaging on a sample 507. Sample 507 may include any sample known in the art including, but not limited to, a wafer, a reticle, a photomask, a flat panel display, and the like. It is noted that system 500 may incorporate one or more of the various embodiments of the broadband LSP light source 100 described throughout the present disclosure.

In embodiments, sample 507 is disposed on a stage assembly 512 to facilitate movement of sample 507. Stage assembly 512 may include any stage assembly 512 known in the art including, but not limited to, an X-Y stage, an R-θ stage, and the like. In embodiments, stage assembly 512 adjusts the height of sample 507 during inspection or imaging to maintain focus on sample 507.

In embodiments, the illumination arm 503 is configured to direct broadband light 109 from the broadband LSP light source 100 to the sample 507. The illumination arm 503 may include any number and type of optical components known in the art. In embodiments, the illumination arm 503 includes one or more optical elements 502, a beam splitter 504, and an objective lens 506. In this regard, illumination arm 503 may be configured to focus broadband light 109 from the broadband LSP light source 100 onto the surface of the sample 507. The one or more optical elements 502 may include any optical element or combination of optical elements known in the art including, but not limited to, one or more mirrors, one or more lenses, one or more polarizers, one or more gratings, one or more filters, one or more beam splitters, and the like. It is noted herein that the collection location may include, but is not limited to, one or more of the optical elements 502, a beam splitter 504, or an objective lens 506.

In embodiments, system 500 includes a collection arm 505 configured to collect light reflected, scattered, diffracted, and/or emitted from sample 507. In another embodiment, collection arm 505 may direct and/or focus the light from the sample 507 to a sensor 516 of a detector assembly 514. It is noted that sensor 516 and detector assembly 514 may include any sensor and detector assembly known in the art. The sensor 516 may include, but is not limited to, a CCD sensor or a CCD-TDI sensor. Further, sensor 516 may include, but is not limited to, a line sensor or an electron-bombardment line sensor.

In embodiments, detector assembly 514 is communicatively coupled to a controller 518 including one or more processors 520 and memory 522. For example, the one or more processors 520 may be communicatively coupled to memory 522, wherein the one or more processors 520 are configured to execute a set of program instructions stored on memory 522. In one embodiment, the one or more processors 520 are configured to analyze the output of detector assembly 514. In one embodiment, the set of program instructions are configured to cause the one or more processors 520 to analyze one or more characteristics of sample 507. In another embodiment, the set of program instructions are configured to cause the one or more processors 520 to modify one or more characteristics of system 500 in order to maintain focus on the sample 507 and/or the sensor 518. For example, the one or more processors 520 may be configured to adjust the objective lens 506 or one or more optical elements 502 in order to focus broadband light 117 from broadband LSP light source 100 onto the surface of the sample 507. By way of another example, the one or more processors 520 may be configured to adjust the objective lens 506 and/or one or more optical elements 510 in order to collect illumination from the surface of the sample 507 and focus the collected illumination on the sensor 516.

It is noted that the system 500 may be configured in any optical configuration known in the art including, but not limited to, a dark-field configuration, a bright-field orientation, and the like. The system 500 may be configured as any type of metrology tool known in the art such as, but not limited to, a spectroscopic ellipsometer with one or more angles of illumination, a spectroscopic ellipsometer for measuring Mueller matrix elements (e.g., using rotating compensators), a single-wavelength ellipsometer, an angle-resolved ellipsometer (e.g., a beam-profile ellipsometer), a spectroscopic reflectometer, a single-wavelength reflectometer, an angle-resolved reflectometer (e.g., a beam-profile reflectometer), an imaging system, a pupil imaging system, a spectral imaging system, or a scatterometer.

Additional details of various embodiments of optical characterization system 500 are described in U.S. Pat. No. 7,957,066B2, entitled “Split Field Inspection System Using Small Catadioptric Objectives,” issued on Jun. 7, 2011; U.S. Published Patent Application 2007/0002465, entitled “Beam Delivery System for Laser Dark-Field Illumination in a Catadioptric Optical System,” published on Jan. 4, 2007; U.S. Pat. No. 5,999,310, entitled “Ultra-broadband UV Microscope Imaging System with Wide Range Zoom Capability,” issued on Dec. 7, 1999; U.S. Pat. No. 7,525,649 entitled “Surface Inspection System Using Laser Line Illumination with Two Dimensional Imaging,” issued on Apr. 28, 2009; U.S. Published Patent Application 2013/0114085, entitled “Dynamically Adjustable Semiconductor Metrology System,” by Wang et al. and published on May 9, 2013; U.S. Pat. No. 5,608,526, entitled “Focused Beam Spectroscopic Ellipsometry Method and System, by Piwonka-Corle et al., issued on Mar. 4, 1997; and U.S. Pat. No. 6,297,880, entitled “Apparatus for Analyzing Multi-Layer Thin Film Stacks on Semiconductors,” by Rosencwaig et al., issued on Oct. 2, 2001, which are each incorporated herein by reference in their entirety.

The one or more processors 520 of the present disclosure may include any one or more processing elements known in the art. In this sense, the one or more processors 520 may include any microprocessor-type device configured to execute software algorithms and/or instructions. In one embodiment, the one or more processors 520 may consist of a desktop computer, mainframe computer system, workstation, image computer, parallel processor, or other computer system (e.g., networked computer) configured to execute a program configured to operate the system 500 and/or broadband LSP light source 100, as described throughout the present disclosure. It should be recognized that the steps described throughout the present disclosure may be carried out by a single computer system or, alternatively, multiple computer systems. In general, the term “processor” may be broadly defined to encompass any device having one or more processing elements, which execute program instructions from a non-transitory memory medium 522. Moreover, different subsystems of the various systems disclosed may include processor or logic elements suitable for carrying out at least a portion of the steps described throughout the present disclosure. Therefore, the above description should not be interpreted as a limitation on the present disclosure but merely an illustration.

The memory medium 522 may include any storage medium known in the art suitable for storing program instructions executable by the associated one or more processors 520. For example, the memory medium 522 may include a non-transitory memory medium. For instance, the memory medium 522 may include, but is not limited to, a read-only memory, a random-access memory, a magnetic or optical memory device, a magnetic tape, a solid-state drive, and the like. In another embodiment, the memory 522 is configured to store one or more results and/or outputs of the various steps described herein. It is further noted that memory 522 may be housed in a common controller housing with the one or more processors 520. In an alternative embodiment, the memory 522 may be located remotely with respect to the physical location of the processors 520. For instance, the one or more processors 520 may access a remote memory (e.g., server), accessible through a network (e.g., internet, intranet, and the like). In another embodiment, memory medium 522 maintains program instructions for causing the one or more processors 520 to carry out the various steps described through the present disclosure.

One skilled in the art will recognize that the herein described components, operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

1. A laser-sustained broadband light source comprising:
a laser pump source configured to generate one or more laser pump beams for sustaining a plasma;
a gas chamber assembly comprising:
a chamber configured to contain a gas;
a laser input configured to couple the one or more laser pump beams from the laser pump source into a plasma region within the chamber to sustain the plasma;
a laser output configured to transmit unabsorbed laser pump light outside of the chamber;
one or more broadband output windows configured to transmit broadband light from the plasma outside of the chamber;
one or more transparent nozzles positioned within the chamber and configured to direct gas flow into a plasma region and transmit the one or more laser pump beams to the plasma region;
one or more transparent structures positioned within the chamber and configured to shield one or more optical collection paths from gas flow;
one or more gas inlets; and
one or more gas outlets, wherein the one or more gas inlets and the one or more gas outlets are configured to provide a flow of the gas through the plasma region; and
a light collector element configured to collect broadband light emitted from the plasma and transmitted through the one or more broadband output windows.

2. The laser-sustained plasma light source of claim 1, wherein the laser input comprises one or more of a lens, a window, or a filter.

3. The laser-sustained plasma light source of claim 1, wherein the laser input comprises at least one of a sapphire lens or sapphire window.

4. The laser-sustained plasma light source of claim 1, wherein the laser output comprises one or more of a lens, a window, or a filter.

5. The laser-sustained plasma light source of claim 1, wherein the laser output comprises at least one of a sapphire lens or sapphire window.

6. The laser-sustained plasma light source of claim 1, wherein the one or more broadband output windows comprise one or more materials transparent to vacuum ultraviolet light.

7. The laser-sustained plasma light source of claim 1, wherein the one or more broadband output windows comprise at least one of magnesium fluoride, lithium fluoride, calcium fluoride, or sapphire.

8. The laser-sustained plasma light source of claim 1, wherein the chamber comprises metal.

9. The laser-sustained plasma light source of claim 1, wherein the one or more transparent nozzles comprise one or more sapphire nozzles.

10. The laser-sustained plasma light source of claim 1, wherein the one or more transparent structures comprise one or more transparent cones.

11. The laser-sustained plasma light source of claim 10, wherein the one or more transparent cones comprise one or more sapphire cones.

12. The laser-sustained plasma light source of claim 1, further comprising a gas junction configured to couple the one or more transparent structures and the one or more transparent nozzles.

13. The laser-sustained plasma light source of claim 1, wherein the gas chamber assembly comprises water-cooling channels.

14. The laser-sustained plasma light source of claim 1, wherein the light collector element comprises at least one of a mirror or a lens.

15. The laser-sustained plasma light source of claim 1, further comprising a retroreflecting mirror positioned to reflect broadband light emitted from the plasma back through the chamber to enhance light collection efficiency.

16. The laser-sustained plasma light source of claim 1, further comprising one or more optical elements configured to provide a multi-pass optical configuration to direct broadband light emitted from the plasma through multiple collection paths to increase light collection efficiency.

17. The laser-sustained plasma light source of claim 1, wherein the gas contained within the chamber comprises at least one of argon, krypton, xenon, or a mixture of two or more of argon, krypton, or xenon.

18. A characterization system comprising:
a laser-sustained light source comprising:
a laser pump source configured to generate one or more laser pump beams for sustaining a plasma;
a gas chamber assembly comprising:
a chamber configured to contain a gas;
a laser input configured to couple the one or more laser pump beams from the laser pump source into a plasma region within the chamber to sustain the plasma;
a laser output configured to transmit unabsorbed laser pump light outside of the chamber;
one or more broadband output windows configured to transmit broadband light from the plasma outside of the chamber;
one or more transparent nozzles positioned within the chamber and configured to direct gas flow into a plasma region and transmit the one or more laser pump beams to the plasma region;
one or more transparent structures positioned within the chamber and configured to shield one or more optical collection paths from gas flow;
one or more gas inlets; and
one or more gas outlets, wherein the one or more gas inlets and the one or more gas outlets are configured to provide a flow of the gas through the plasma region; and
a light collector element configured to collect broadband light emitted from the plasma and transmitted through the one or more broadband output windows,
wherein the characterization system further comprises:
a set of illumination optics configured to direct broadband light from the laser-sustained light source to one or more samples;
a set of collection optics configured to collect light emanating from the one or more samples; and
a detector assembly.

19. The characterization system of claim 18, wherein the laser input comprises one or more of a lens, a window, or a filter.

20. The characterization system of claim 18, wherein the laser input comprises at least one of a sapphire lens or sapphire window.

21. The characterization system of claim 18, wherein the laser output comprises one or more of a lens, a window, or a filter.

22. The characterization system of claim 18, wherein the laser output comprises at least one of a sapphire lens or sapphire window.

23. The characterization system of claim 18, wherein the one or more broadband output windows comprise one or more materials transparent to vacuum ultraviolet light.

24. The characterization system of claim 18, wherein the one or more broadband output windows comprise at least one of magnesium fluoride, lithium fluoride, calcium fluoride, or sapphire.

25. The characterization system of claim 18, wherein the chamber comprises metal.

26. The characterization system of claim 18, wherein the one or more transparent nozzles comprise one or more sapphire nozzles.

27. The characterization system of claim 18, wherein the one or more transparent structures comprise one or more transparent cones.

28. The characterization system of claim 27, wherein the one or more transparent cones comprise one or more sapphire cones.

29. The characterization system of claim 18, wherein the one or more transparent cones comprise one or more sapphire cones.

30. The characterization system of claim 18, further comprising a gas junction configured to couple the one or more transparent structures and the one or more transparent nozzles.

31. The characterization system of claim 18, wherein the gas chamber assembly comprises water-cooling channels.

32. The characterization system of claim 18, wherein the light collector element comprises at least one of a mirror or a lens.

33. The characterization system of claim 18, further comprising a retroreflecting mirror positioned to reflect broadband light emitted from the plasma back through the chamber to enhance light collection efficiency.

34. The characterization system of claim 18, further comprising one or more optical elements configurated to provide a multi-pass optical configuration to direct broadband light emitted from the plasma through multiple collection paths to increase light collection efficiency.

35. The characterization system of claim 18, wherein the gas contained within the chamber comprises at least one of argon, krypton, xenon, or a mixture of two or more of argon, krypton, or xenon.

36. A method for generating broadband vacuum-ultraviolet light comprising:
providing a gas chamber assembly comprising:
a chamber configured to contain a gas;
a laser input configured to couple one or more laser pump beams into a plasma region within the chamber to sustain a plasma;
a laser output configured to transmit unabsorbed laser pump light outside the chamber;
one or more broadband output windows configured to transmit broadband light from the plasma outside the chamber;
one or more transparent nozzles positioned within the chamber and configured to direct gas flow into the plasma region;
one or more transparent cones positioned within the chamber and configured to shield one or more optical collection paths from gas flow;
one or more gas inlets; and
one or more gas outlets;
generating one or more laser pump beams with a laser pump source;
coupling the one or more laser pump beams into the plasma region via the laser input to sustain the plasma;
flowing the gas through the plasma region by:
supplying the gas through the one or more gas inlets;
directing the gas into the plasma region through the transparent nozzles; and
exhausting the gas through the one or more gas outlets;
collecting broadband light emitted from the plasma and transmitted through the one or more broadband output windows with a light collector element; and
transmitting unabsorbed laser pump light outside the chamber via the laser output.
